(19) United States
(12) Patent Application Publication
(10) Pub. No.: US 2014/0089716 A1
(43) Pub. Date: Mar. 27, 2014

(54) PROCESSING DEVICE AND METHOD FOR REDUCING NOISE

(71) Applicant: FUJITSU LIMITED, Kawasaki-shi (JP)

(72) Inventor: Yuusuke KISHI, Kahoku (JP)

(73) Assignee: FUJITSU LIMITED, Kawasaki-shi (JP)

(21) Appl. No.: 14/036,042

(22) Filed: Sep. 25, 2013

(30) Foreign Application Priority Data
Sep. 27, 2012 (JP) 2012-215168

(51) Int. Cl. G06F 1/26

(52) U.S. Cl. CPC G06F 1/26
USPC 713/340

(57) ABSTRACT

A processing device includes: a channel adaptor connected to an external device; a first resistor provided parallel to the channel adaptor, and has a variable resistance value; a processor to control the resistance value of the first resistor; a power supply device to provide power; a second resistor provided between the power supply device and the channel adaptor; a switch to control continuity of a current from the power supply device to the channel adaptor and the first resistor; and a controller to monitor a voltage of the second resistor, and turn off the switch when the voltage is larger than a threshold. The processor calculates a resistance value to be set in the first resistor based on a current of the second resistor, the threshold, and a resistance value of the second resistor, and sets the calculated resistance value as the resistance value of the first resistor.

### CROSS-REFERENCE TO RELATED APPLICATIONS

This application is based upon and claims the benefit of priority of the prior Japanese Patent Application No. 2012-215168, filed on Sep. 27, 2012, the entire contents of which are incorporated herein by reference.

### FIELD

The embodiments discussed herein are related to a processing device and a method for reducing noise.

### BACKGROUND

In a processing device such as an information processing device such as a server etc., a storage device, a communication device etc., a redundant design is adopted not to stop the device by one unit fault. For example, when a power supply and the ground short-circuit in a unit in the redundant arrays of inexpensive disks (RAID), the entire power supply stops as is. However, the stop may be prevented by separating the input side power supply from the output side power supply using the overcurrent detecting function of a hot swap device.

However, although the stop of the power supply is avoided in the conventional method, there is the possibility that large noise is generated by an abrupt fluctuation of a current, and another unit malfunctions by the noise.

FIG. 1 illustrates the generation of ringing noise in a RAID device.

A RAID device 10 includes controller modules 11-1 and 11-2 and a power supply unit 12.

The power supply unit 12 supplies power to the controller modules 11-1 and 11-2.

The controller module 11-1 includes a resistor 13, field effect transistor (FET) 14, and a hot swap controller 15.

The resistor 13 is provided between the power supply unit 12 and the FET 14.

The drain, the gate, and the source of the FET 14 are respectively connected to the resistor 13, the hot swap controller 15, and a hot swap device (not illustrated in the attached drawings).

The hot swap controller 15 controls the hot swap of the hot swap device (not illustrated in the attached drawings).

The hot swap controller 15 controls the ON and OFF states of the current between the drain and the source by controlling the gate voltage of the FET 14.

The hot swap controller 15 measures the potential difference (voltage) at both ends of the resistor 13, and when the voltage of the resistor 13 is larger than the threshold (voltage threshold), the FET 14 is turned off, and the current is cut off. The value obtained by dividing the voltage threshold by the resistance of the resistor 13 is called an overcurrent threshold. Since the equation “voltage=resistance×current” holds true, the hot swap controller 15 turns off the FET 14 and cuts off the current when the current passing through the resistor 13 is larger than the overcurrent threshold.

When the output side power supply (source) of the FET 14 and the ground short-circuit, the current which passes through the resistor 13 increases, and the voltage of the resistor 13 also increases.

The hot swap controller 15 turns off the FET 14 and cuts off the current if the voltage of the resistor 13 exceeds the voltage threshold (that is, when the current of the resistor 13 exceeds the overcurrent threshold).

When the FET 14 enters the OFF state, ringing noise occurs on the input power supply side (drain side of the FET 14) by the inductor component parasitic on the substrate and a sudden change in current.

When the ringing noise which has occurred in the controller module 11-1 reaches the controller module 11-2 which shares the power supply unit 12, the controller module 11-2 may malfunction.

FIG. 2 is a graph of the current and the voltage when a conventional short circuit occurs.

In FIG. 2, the graph on the left indicates the current of the resistor 13, and the graph on the right indicates the voltage of the resistor 13.

On the right in FIG. 2, a short circuit occurs at time t1, and the current increases. At time t2, the hot swap controller 15 detects that the current exceeds the overcurrent threshold (that is, the voltage of the resistor 13 exceeds the threshold voltage). At time t3, the hot swap controller 15 cuts off the current by turning off the FET 14.

The time period from the occurrence of the short circuit to the turnoff of the FET 14 is Δt1, and the difference in current between the current when the FET 14 is turned off and the current before the occurrence of the short circuit is ΔI1.

As illustrated on the right in FIG. 2, large noise occurs at the moment of a change in current.

Assuming that Vnoise indicates the voltage of the noise, L indicates the parasitic inductor, ΔI indicates the fluctuation of the current, and Δt indicates the time at which the current changes, Vnoise is calculated by the following equation (1).

Vnoise=L*(ΔI/Δt) (1)

That is, the larger the fluctuation of the current, the larger the noise grows.

In the conventional RAID device, the overcurrent threshold is obtained by adding a margin to the load (current consumption) detected with the largest configuration of the RAID device. Therefore, when the RAID device has the smallest configuration, the power consumption is small, thereby increasing the difference between the overcurrent threshold and the current consumption. Accordingly, when the RAID device has the smallest configuration, large ringing noise occurs when a short circuit occurs.

[Patent Document 1] Japanese Laid-open Patent Publication No. H05-327244

[Patent Document 2] Japanese Laid-open Patent Publication No. 2007-220149

### SUMMARY

According to an aspect of the invention, the processing device includes a channel adaptor, a first resistor, a processor, a power supply device, a second resistor, a switch, and a switch controller.

The channel adaptor is connected to an external device.

The first resistor is provided parallel to the channel adaptor, and has a variable resistance value.

The processor controls the resistance value of the first resistor.

The power supply device provides power for the channel adaptor and the first resistor.

The second resistor is provided between the power supply device and the channel adaptor.

The switch controls the continuity of the current from the power supply device to the channel adaptor and the first resistor.

The switch controller monitors the voltage of the second resistor, and places the switch in the off position when the voltage is larger than the threshold.

The processor calculates a resistance value to be set in the first resistor based on the current of the second resistor, the threshold, and a resistance value of the second resistor, and sets the calculated resistance value as the resistance value of the first resistor.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates the occurrence of ringing noise in the conventional RAID device.

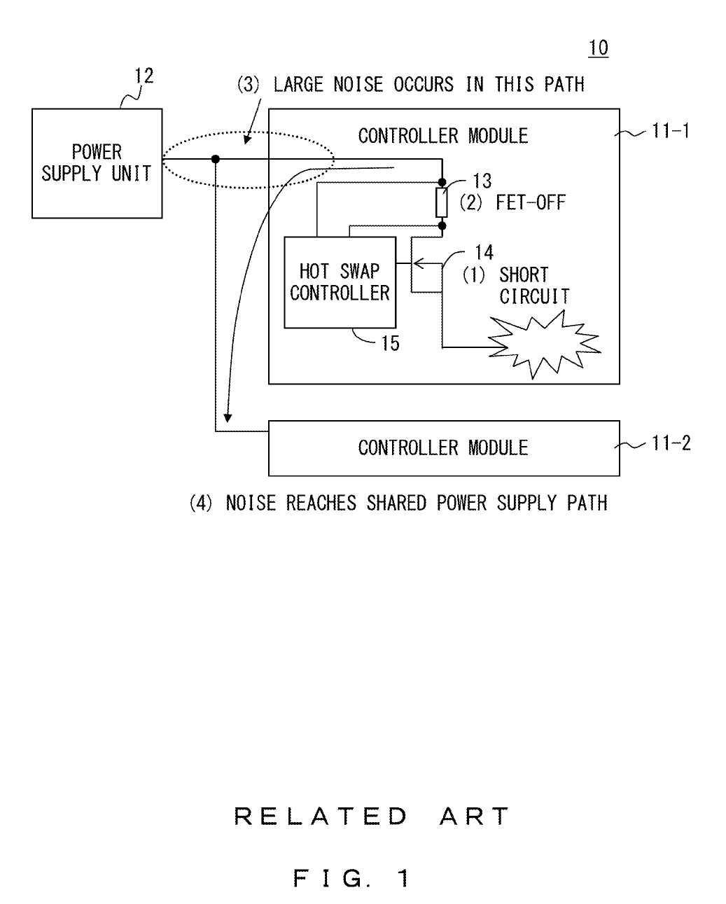

FIG. 2 is a graph of the current and the voltage when a conventional short circuit occurs;

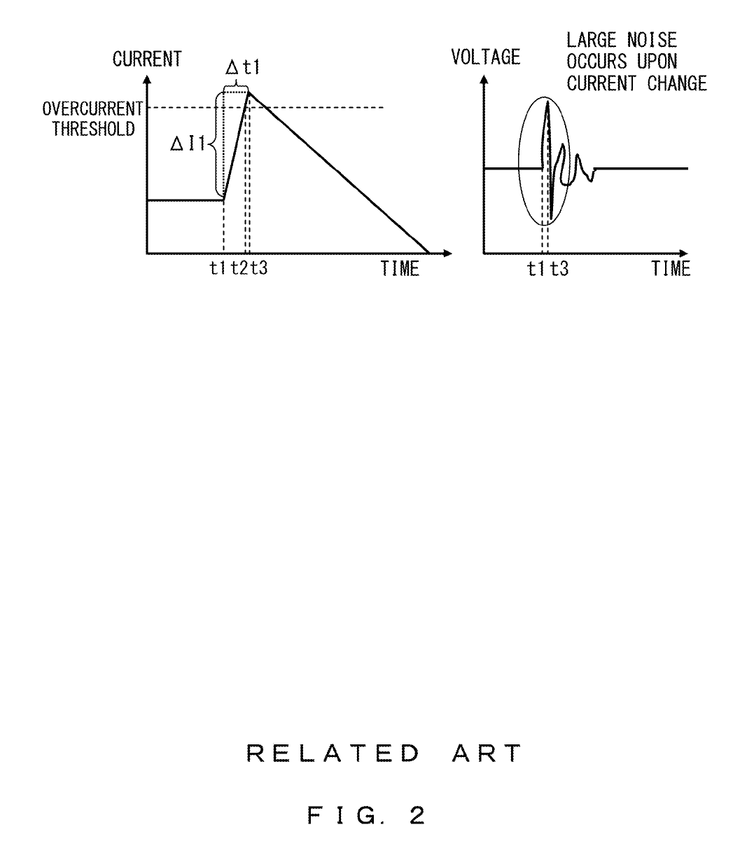

FIG. 3 is a configuration of the RAID device according to an embodiment;

FIG. 4 is a configuration of a controller module according to the first embodiment;

FIG. 5 illustrates a current value table;

FIG. 6 is a flowchart of the variable resistance setting process according to the first embodiment;

FIG. 7 illustrates the resistance value calculated for each configuration;

FIG. 8 is a graph of the current and the voltage when a short circuit occurs after changing the resistance value according to the first embodiment;

FIG. 9 is a hardware configuration of the controller module according to the first embodiment;

FIG. 10 is a configuration of the controller module according to the second embodiment;

FIG. 11 is a flowchart of the variable resistance setting process according to the second embodiment;

FIG. 12 is a graph of the current and the voltage when a short circuit occurs after changing the resistance value according to the second embodiment;

FIG. 13 is a hardware configuration of the controller module according to the second embodiment;

FIG. 14 is a configuration of the controller module according to the third embodiment;

FIG. 15 is a flowchart of the variable resistance setting process according to the third embodiment;

FIG. 16 is a graph of the current and the voltage when a short circuit occurs after changing the resistance value according to the third embodiment; and

FIG. 17 is a hardware configuration of the controller module according to the third embodiment.

### DESCRIPTION OF EMBODIMENTS

The embodiments are described below with reference to the attached drawings.

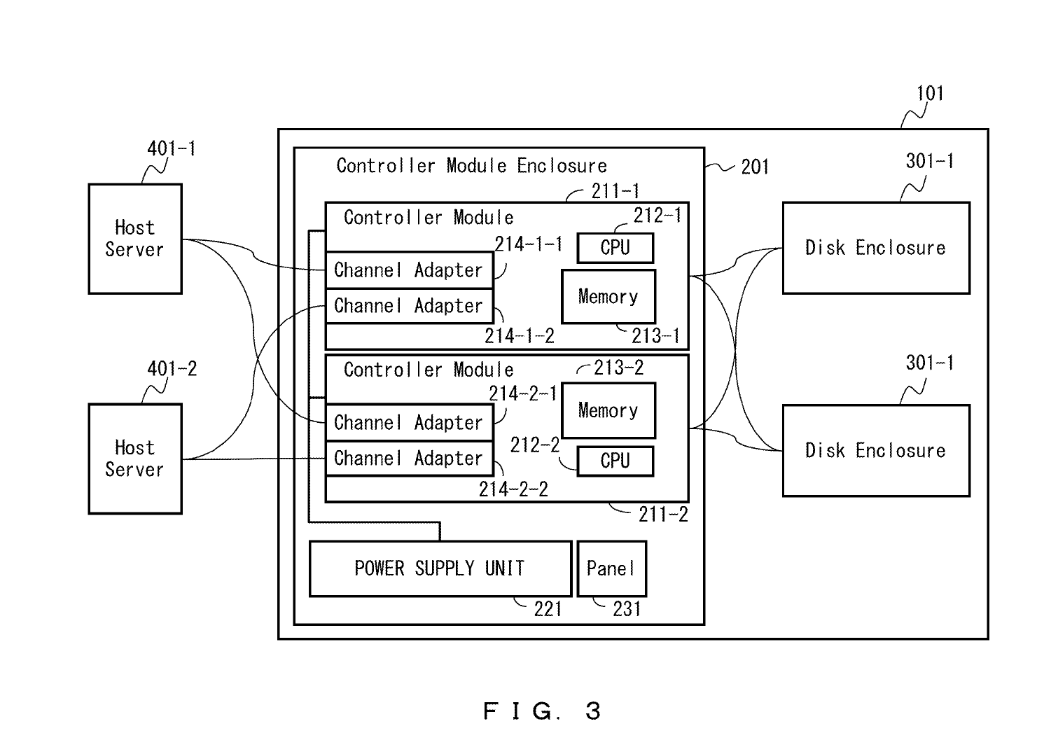

FIG. 3 is a configuration of the RAID device according to an embodiment.

A RAID device 101 includes a controller module enclosure 201 and a disk enclosure 301-i (i=1, 2).

The controller module enclosure 201 includes a controller module 211-i, a power supply unit 221, and a panel 231.

The controller module 211-i includes a CPU 212-i, memory 213-i, and a channel adaptor 214-i-j (j=1, 2).

The CPU 212-i performs a RAID process such as allocating data, calculating a parity, etc.

The memory 213-i is a storage device which temporarily stores data processed by the RAID device 101.

The channel adaptor 214-i-j is an adapter card connected to a host server 401-j. A channel adaptor 214 and a host server 401 are connected through a local area network (LAN) or a fiber channel.

The power supply unit 221 is a power supply device which supplies power to a controller module 211.

The panel 231 is a user interface which sets the RAID device 101, displays the information about the RAID device 101, etc.

A disk enclosure 301 stores a storage device such as a plurality of hard disk drives (HDD) etc.

The host server 401 transmits write data to the RAID device 101 and issues a write instruction, and issues a read instruction to the RAID device 101 and receives read data from the RAID device 101.

The number of components (a controller module, a channel adaptor, a disk enclosure, etc.) of the RAID device 101 is not limited to the example above, but may be an arbitrary number.

The RAID device 101 is used in each embodiment described below.

### First Embodiment

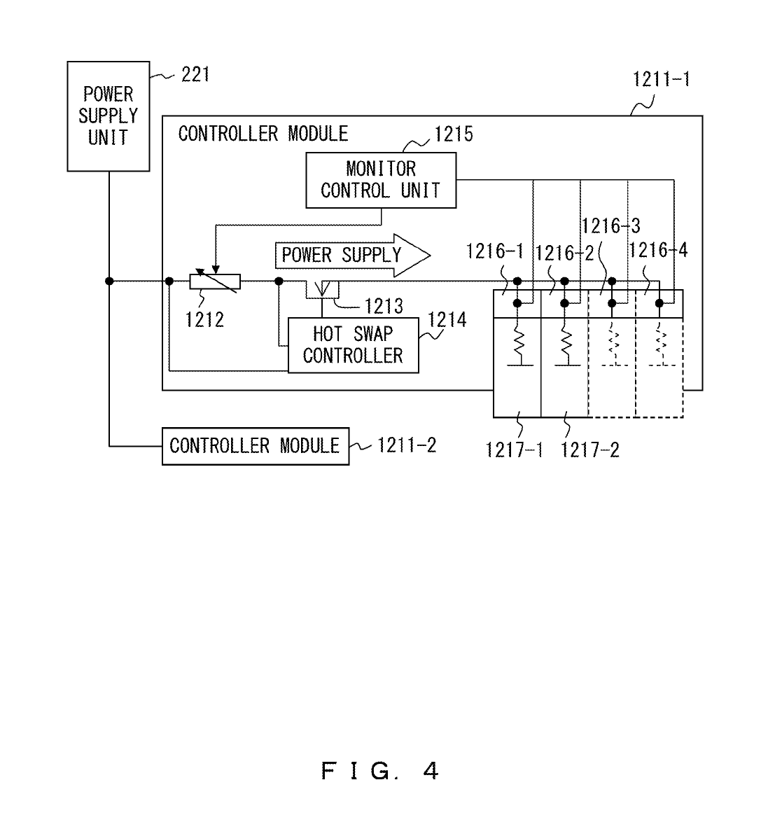

FIG. 4 is a configuration of a controller module according to the first embodiment.

A controller module 1211-i (i=1, 2) corresponds to the controller module 211-i in FIG. 3.

The controller module 1211-i is provided with power from the power supply unit 221.

Since a controller module 1211-2 has a configuration and a function similar to those of a controller module 1211-1, the detailed explanation is given below only on the controller module 1211-1.

The controller module 1211-1 includes a variable resistor (current measurement resistor) 1212, an FET 1213, a hot swap controller 1214, a monitor control unit 1215, a channel adaptor slot 1216-k (k=1˜4), and a channel adaptor 1217-i.

The variable resistor 1212 is provided between the power supply unit 221 and the FET 1213. The variable resistor 1212 is realized by, for example, a plurality of resistors connected in parallel or FET.

The drain, the gate, and the source of the FET 1213 are respectively connected to the variable resistor 1212, the hot swap controller 1214, and the channel adaptor slot 1216. The FET 1213 is an example of a switch which passes or cuts off a current.

The hot swap controller 1214 controls the hot swap of a controller module 1211-1.

The hot swap controller 1214 controls the gate voltage of the FET 1213, thereby controlling the ON and OFF states of the current between the drain and the source.

The hot swap controller 1214 measures the potential difference (voltage) at both ends of the variable resistor 1212, and turns off the FET 1213 when the voltage of the variable resistor 1212 is larger than the threshold (voltage threshold), thereby cutting off the current. The value obtained by dividing the voltage threshold by the resistance value of the FET 1213 is referred to as an overcurrent threshold. Since the equation “voltage=resistance×current” holds true, the hot swap controller 1214 turns off the FET 1213 and cuts off the current when the current which passes through the variable resistor 1212 is larger than the overcurrent threshold.

The monitor control unit 1215 acquires the configuration information (type and number of the channel adaptor) about the channel adaptor 1217 loaded into the controller module 1211-1, and calculates the resistance value to be set in the variable resistor 1212 based on the current value table. The current value table is stored in the storage unit such as the resistor etc. of the monitor control unit 1215. The current value table is described later in detail.

The monitor control unit 1215 changes the resistance value of the variable resistor 1212 into the calculated resistance value. The overcurrent threshold is also changed by changing the resistance value of the variable resistor 1212.

When the variable resistor 1212 is configured by a plurality of resistors connected in parallel, the change of the resistance value of the variable resistor 1212 is made by switching the plurality of resistors connected in parallel. When the variable resistor 1212 is a FET, the change of the resistance value is realized by controlling the gate voltage of the FET and changing the ON resistance.

When the configuration of the controller module 1211-1 is changed, the monitor control unit 1215 dynamically changes the resistance value of the variable resistor 1212.

The monitor control unit 1215 is realized by, for example, a micro-processing unit (MPU).

The channel adaptor slot 1216 is a socket for plug-in of the channel adaptor 1217. A channel adaptor 1217-i is connected to a channel adaptor slot 1216-i. The channel adaptor 1217 is not connected to channel adaptor slots 1216-3 and 1216-4, which are kept as unused slots.

The channel adaptor 1217 is adapter card connecting to a host server. The channel adaptor 1217 may be swapped with the power supply in the ON state, that is, it may be hot swappable.

The current value table is described below.

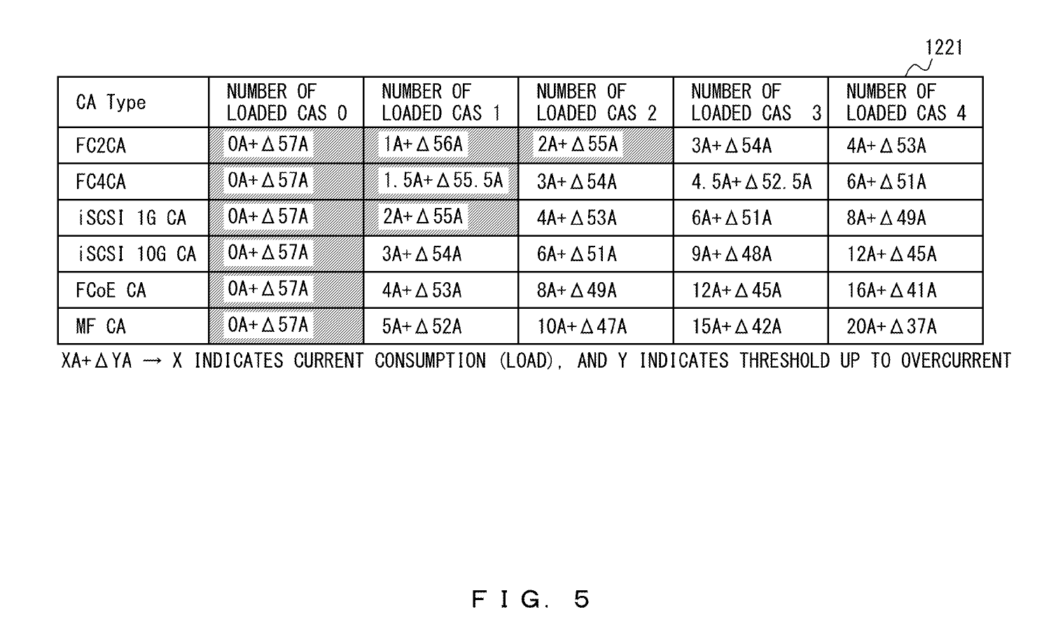

FIG. 5 is a current value table.

Assume that the voltage threshold is 95 mV, and the resistance value of the variable resistor 1212 is 1.67 mΩ, and the overcurrent threshold is 57 A (≈95V/1.67 mΩ).

A current value table 1221 has the items of the type (CA TYPE) of a channel adaptor and the number of loaded channel adaptors from 0 to 4.

The current value table 1221 describes the current consumption (load) and the difference between the overcurrent threshold and the current consumption when a certain number of a certain type of channel adaptors are loaded.

The current value table 1221 illustrated in FIG. 5 describes the current consumption and the difference between the overcurrent threshold and the current consumption in the format of XA+ΔYA.

X indicates the current consumption of the channel adaptor, and ΔY indicates the difference between the overcurrent threshold and the current consumption.

For example, “1 A+Δ56 A” in column 2 in line 1 of the current value table 1221 indicates that the current consumption is 1 A, and the difference between the overcurrent threshold and the current consumption is 56 A when one channel adaptor FC2CA is loaded.

When the difference between the overcurrent threshold and the current consumption indicated by the shading portion in FIG. 5 is large (55 A or more), there is the possibility that a malfunction occurs when a short circuit occurs.

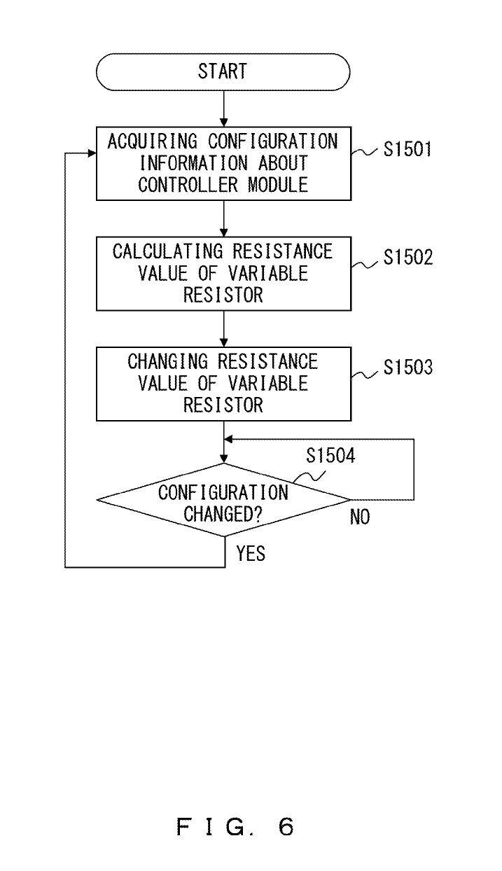

FIG. 6 is a flowchart of the variable resistance setting process according to the first embodiment.

In step S1501, the monitor control unit 1215 acquires the configuration information (type and number of channel adaptors) of the channel adaptor 1217 loaded into the controller module 1211-1.

In step S1502, the monitor control unit 1215 refers to the current value table 1221, and calculates the current consumption of the present configuration. The current consumption is calculated as the total current consumption of the channel adaptors 1217 loaded into the controller module 1211-1.

The monitor control unit 1215 calculates the resistance value so that the difference between the overcurrent threshold and the current consumption may be smaller based on the voltage threshold set in the hot swap controller 1214 and the current consumption of the present configuration.

In this example, the resistance value is calculated to obtain the difference of 37 A between the overcurrent threshold and the current consumption.

For example, as described with reference to FIG. 5, it is assumed that the voltage threshold is 95 mV, one channel adaptor FC2CA is loaded, and the current consumption is 1 A.

In this case, the resistance valued=threshold voltage/(current consumption+difference)=95 mV/(current consumption+difference)=95 mV/(1 A+37 A)=2.5 mΩ.

In step S1503, the monitor control unit 1215 changes the resistance value of the variable resistor 1212 into the value calculated in step S1502. Thus, the value of the overcurrent threshold is also reduced.

In step S1504, the monitor control unit 1215 checks whether or not the configuration of the controller module 1211-1 has been changed by connecting or disconnecting the channel adaptor 1217. When the configuration of the controller module 1211-1 is changed, control is passed to step S1501, and when the configuration of the controller module 1211-1 is not changed, the system enters a standby state until the configuration is changed.

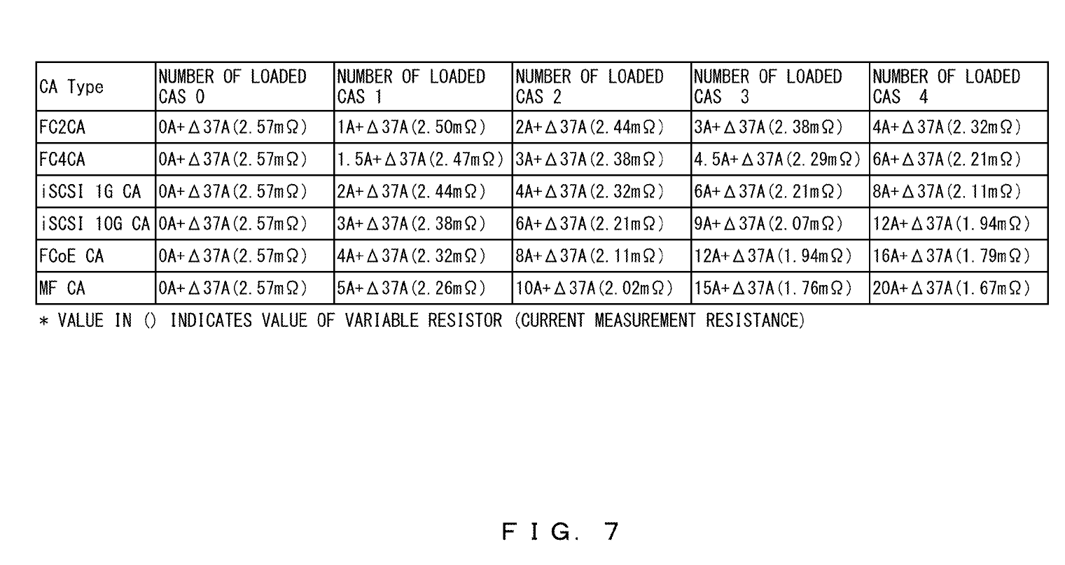

FIG. 7 illustrates the resistance value calculated with each configuration.

With each configuration indicated in the current value table in FIG. 5, FIG. 7 illustrates the resistance value calculated when the difference between the overcurrent threshold and the current consumption is 37 A.

FIG. 7 illustrates the current consumption, the difference between the overcurrent threshold and the current consumption, and the calculated resistance value.

For example, when one channel adaptor FC2CA is loaded, 2.5 mΩ is calculated as a resistance value as described above.

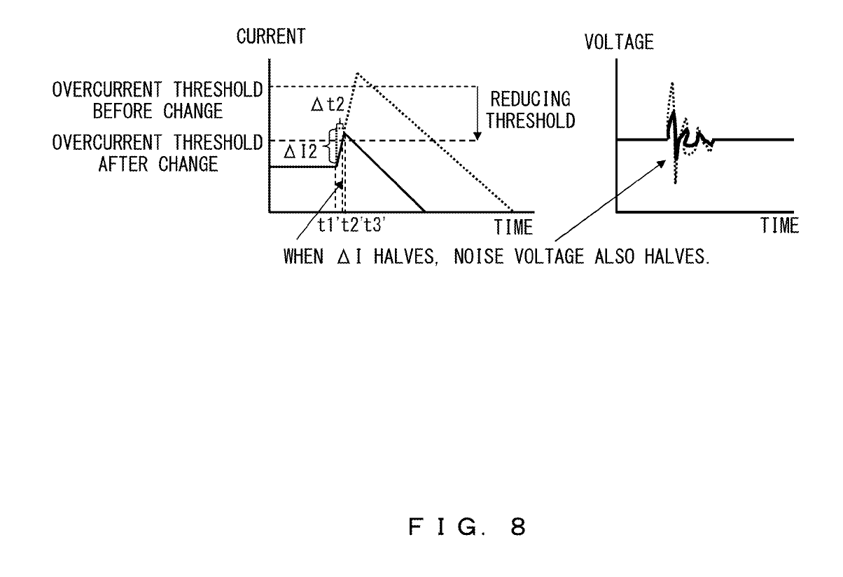

FIG. 8 is a graph of the current and the voltage when a short circuit occurs after the resistance value is changed.

A graph of the current of the variable resistor 1212 is illustrated on the left in FIG. 8, and a graph of the voltage of the variable resistor 1212 is illustrated on the right.

The solid line in FIG. 8 indicates current and voltage graphs after the resistance value is changed, and the dotted line indicates current and voltage graphs before the resistance value is changed (conventionally).

On the left in FIG. 8, a short circuit occurs at time t1′, and the current increases. At time t2′, in the hot swap controller 1214 detects that the current exceeds the overcurrent threshold after a change (that is, the voltage of the variable resistor 1212 exceeds the threshold voltage). At time t3′, the hot swap controller 1214 cuts off the current by turning off the FET 1213.

The overcurrent threshold is reduced by changing the resistance value of the variable resistor 1212. That is, the overcurrent threshold before the change is 57 A, and the overcurrent threshold after the change is 37 A.

Therefore, when a short circuit occurs, the current for which an overcurrent is detected becomes lower, and the difference between the current when the FET 1213 is turned off and the current before the occurrence of a short circuit is also reduced. Therefore, the voltage of the noise which occurs as illustrated on the right in FIG. 8.

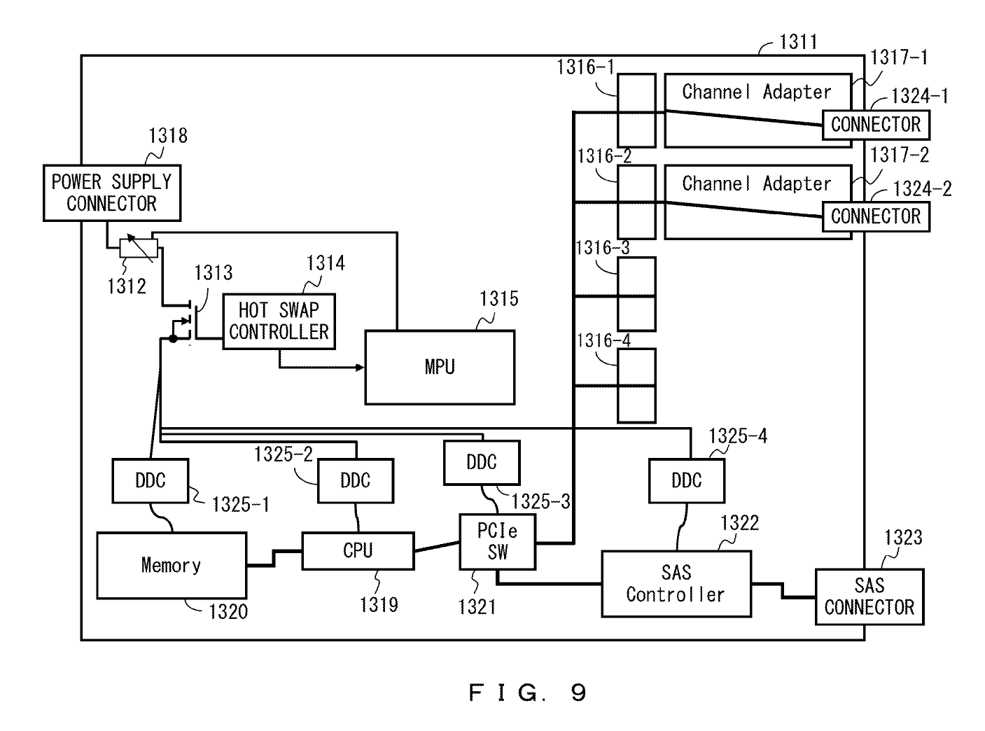

FIG. 9 is a hardware configuration of the controller module according to the first embodiment.

A controller module 1211 may be realized by, for example, a controller module 1311 as illustrated in FIG. 9.

The controller module 1311 includes a variable resistor 1312, a FET 1313, a hot swap controller 1314, an MPU 1315, a channel adaptor slot 1316-k, a channel adaptor 1317-i, a power supply connector 1318, a CPU 1319, memory 1320, a peripheral component interconnect express (PCIe) switch 1321, a serial attached SCSI (SAS) controller 1322, a SAS connector 1323, and a DC-DC converter (DDC) 1325-k.

The variable resistor 1212, the FET 1213, the hot swap controller 1214, the monitor control unit 1215, the channel adaptor slot 1216-k, and the channel adaptor 1217-i in FIG. 4 respectively correspond to the variable resistor 1312, the FET 1313, the hot swap controller 1314, the MPU 1315, the channel adaptor slot 1316-k, and the channel adaptor 1317-i.

The channel adaptor 1317-i includes a connector 1324-i.

A connector 1324 is a connector connected to the host server. The connector 1324 is, for example, a LAN connector, or a fiber channel connector.

The power supply connector 1318 is a connector connected to the power supply unit.

The CPU 1319 performs the RAID process such as allocating data, calculating a parity, etc.

The memory 1320 is a storage device which temporarily stores data processed by the controller module 1311.

The PCIe switch 1321 relays data among the CPU 1319, a channel adaptor 1317, and the SAS controller 1322.

The SAS controller 1322 is a controller which controls a SAS.

The SAS connector 1323 is a connector connected to a disk enclosure using the SAS.

A DC-DC converter (DDC) 1325 is a converter which converts a direct current voltage.

According to the controller module of the first embodiment, the overcurrent threshold is reduced by changing the resistance value of a variable resistor, and the fluctuation of the current when a short circuit occurs is reduced, thereby reducing the noise voltage. Thus, the possibility that other units malfunction which share input power supply may be reduced.

### Second Embodiment

In the second embodiment, the resistance value of a dummy load (variable resistor) is changed to compensate for the load of a channel adaptor which has not been implemented from the load value (current consumption value) obtained from the current measurement resistance, and an abrupt current fluctuation is suppressed from the load to the threshold for detection of an overcurrent, thereby reducing the noise voltage.

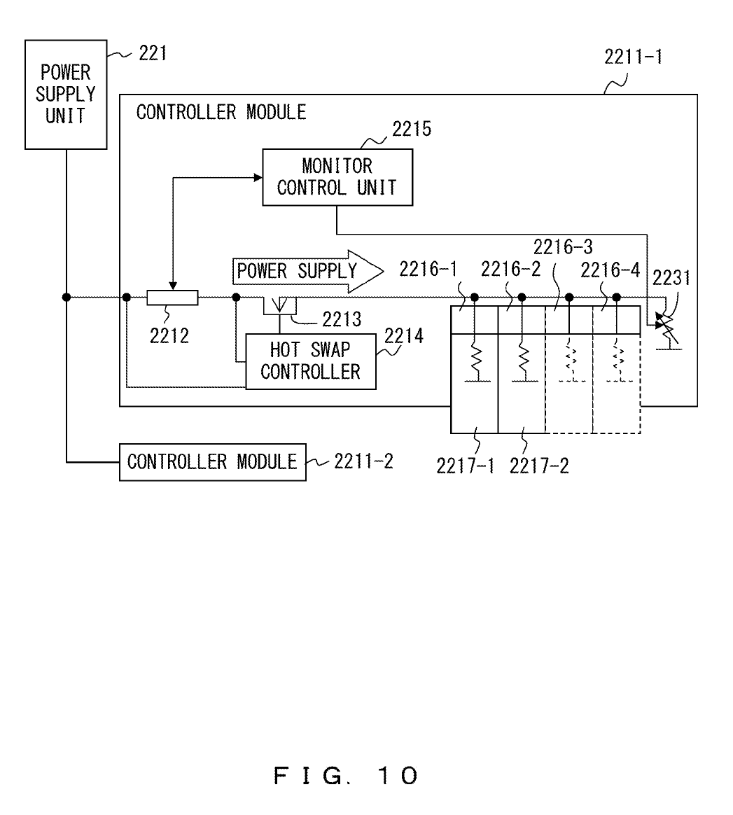

FIG. 10 is a configuration of the controller module according to the second embodiment.

A controller module 2211-i (i=1, 2) corresponds to the controller module 211-i in FIG. 3.

the controller module 2211-i is provided with power from the power supply unit 221.

Since a controller module 2211-2 has a configuration and a function similar to those of to controller module 2211-1, only the controller module 2211-1 is described in detail.

The controller module 2211-1 includes a resistor (current measurement resistance) 2212, a FET 2213, a hot swap controller 2214, a monitor control unit 2215, a channel adaptor slot 2216-k (k=1˜4), a channel adaptor 2217-i, and a variable resistor 2231.

The resistor 2212 is provided between the power supply unit 221 and the FET 2213.

The drain, the gate, and the source of the FET 2213 are respectively connected to the resistor 2212, the hot swap controller 2214, and a channel adaptor slot 2216 and the variable resistor 2231. The FET 2213 is an example of a switch which passes or cuts off a current.

The hot swap controller 2214 controls the hot swap of a controller module 2211-1.

The hot swap controller 2214 controls the gate voltage of the FET 2213, thereby controlling the ON and OFF states of a current between the drain and the source.

The hot swap controller 2214 measures the potential difference (voltage) at both ends of the resistor 2212, and when the voltage of the resistor 2212 is larger than the threshold (voltage threshold), it turns off the FET 2213, thereby cutting off the current. Furthermore, the value obtained by dividing the voltage threshold by the resistance value of the FET 2213 is referred to as an overcurrent threshold. Since the equation “voltage=resistance×current” holds true, the hot swap controller 2214 turns off the FET 2213 to cut off the current when the current which passes through the resistor 2212 is larger than the overcurrent threshold.

The monitor control unit 2215 acquire the value of the current of the resistor 2212, and calculates the resistance value to be set in the variable resistor 2231 based on the current of the resistor 2212.

The monitor control unit 2215 changes the resistance value of the variable resistor 2231 into the calculated resistance value. The power consumption is also changed by changing the resistance value of the variable resistor 2231.

When the variable resistor 2231 is configured by a plurality of resistors connected in parallel, the change of the resistance value of the variable resistor 2231 is made by switching the plurality of resistors connected in parallel. When the variable resistor 2231 is a FET, the change of the resistance value is realized by controlling the gate voltage of the FET and changing the ON resistance.

When the configuration of the controller module 1211-1 is changed, the monitor control unit 1215 dynamically changes the resistance value of the variable resistor 1212.

The monitor control unit 1215 is realized by, for example, a micro-processing unit (MPU) which executes firmware.

Since the channel adaptor slot 2216 and the channel adaptor 2217 have a function and a configuration similar to those of the channel adaptor slot 1216 and the channel adaptor 1217 respectively in the first embodiment, they are not described in detail below.

The variable resistor 2231 is provided parallel to the channel adaptor slot 2216. The variable resistor 2231 is realized by, for example, a plurality of resistors connected in parallel or FET.

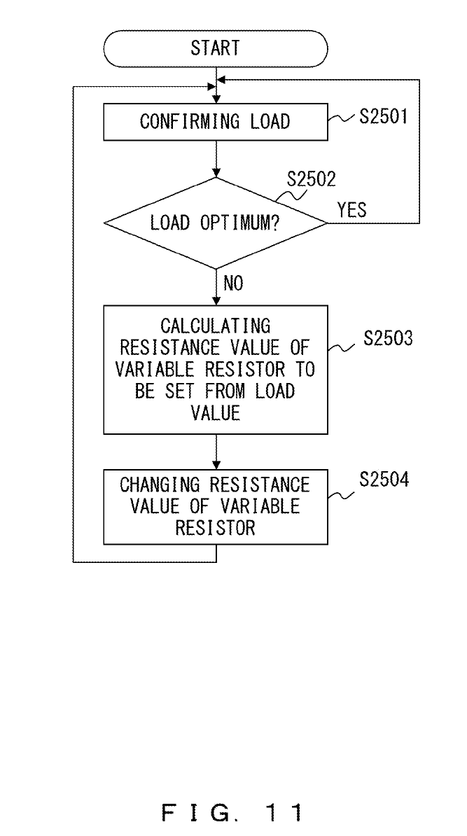

FIG. 11 is a flowchart of the variable resistance setting process according to the second embodiment.

In step S2501, the monitor control unit 2215 measures and conforms the current (current consumption) which passes through the resistor 2212. The current which passes through the resistor 2212 is also referred to as a current consumption or a load. In the initial state, the current is prevented from passing through the variable resistor 2231. That is, the resistance value of the variable resistor 2231 is infinite.

In step S2502, the monitor control unit 2215 judges whether or not the current consumption is appropriate. For example, when the difference between the overcurrent threshold and the current consumption is equal to or less than a specified threshold, or when the current consumption is equal to or larger than the value obtained by multiplying the overcurrent threshold by a coefficient (for example, 0.8), then it is judged that the current consumption is appropriate. That is, when the difference between the overcurrent threshold and the current consumption is small, it is judged that the current consumption is appropriate. When the current consumption is appropriate, control is returned to step S2501. When the current consumption is not appropriate, control is passed to step S2503.

In step S2503, the monitor control unit 2215 calculates the resistance value set in the variable resistor 2231 based on the present current consumption.

In detail, the monitor control unit 2215 first calculates the value of the target current consumption obtained by the equation “coefficient*threshold voltage of hot swap controller 2214/resistance value of resistor 2212”.

The coefficient is a real number larger than 0 and smaller than 1. However, when the coefficient is too small, the value of the target current consumption is also small, and the difference between the overcurrent threshold and the target current consumption becomes larger. Therefore, the fluctuation of the current becomes large when a short circuit occurs, and the noise also becomes large. Therefore, it is assumed that the coefficient is an appropriate value which is not too small.

It is assumed that the coefficient=0.8, the threshold voltage=50 mV, and the resistance value of the resistor 2212=5 mΩ. The current value of the resistor 2212, that is, the present current consumption, is 5 A.

Therefore, the value of the target current consumption=0.8*50 mV/5 mΩ=8 A.

The insufficient current is calculated by the difference between the value of the target current consumption and the present current consumption by the equation “3 A (=8 A−5 A)”

The monitor control unit 2215 divides the voltage of the variable resistor 2231 by the insufficient current, and calculates the resistance value set in the variable resistor 2231. The voltage of the variable resistor 2231 is determined in advance, and the monitor control unit 2215 is informed of the voltage of the variable resistor 2231 in advance.

In step S2504, the monitor control unit 2215 changes the resistance value of the variable resistor 2231 into the resistance value calculated in step S2503. Thus, the current (current consumption) which passes through the resistor 2212 increases.

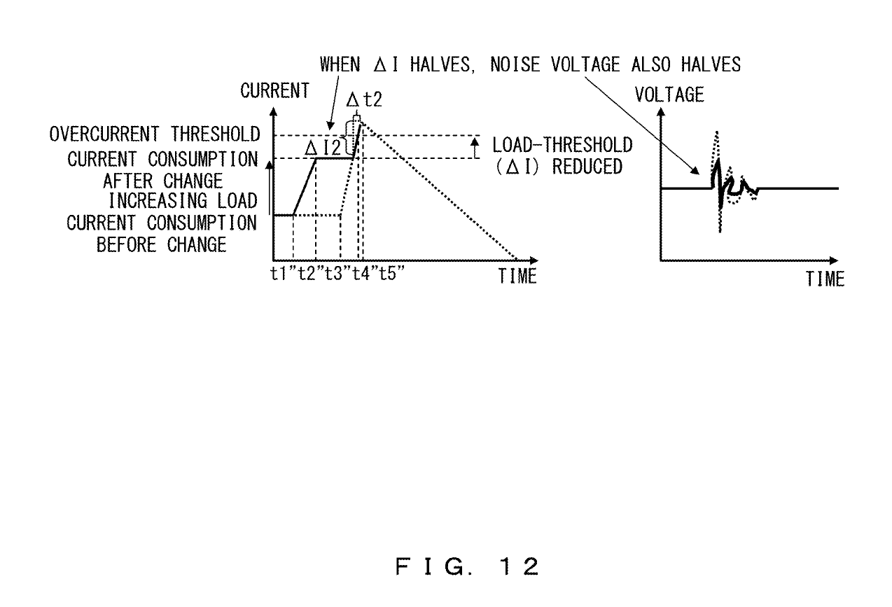

FIG. 12 is a graph of the current and the voltage when a short circuit occurs after changing the resistance value.

A graph of the current of the resistor 2212 is illustrated on the left of FIG. 12, and a graph of the voltage of the resistor 2212 is illustrated on the right.

The solid line in FIG. 12 indicates current and voltage graphs after the resistance value is changed, and the dotted line indicates current and voltage graphs before the resistance value is changed (conventionally).

On the left in FIG. 12, the resistance value of the variable resistor 2231 is calculated based on the present current consumption at time t1″, and changes the resistance value of the variable resistor 2231.

Thus, the current consumption increases, and the current consumption is a target current consumption at time t2″.

A short circuit occurs at time t3″, and the current increases. At time t4″, the hot swap controller 2214 detects that the current exceeds the overcurrent threshold (that is, the voltage of the variable resistor 2212 exceeds the threshold voltage). At time t5″, the hot swap controller 2214 cuts off the current by turning off the FET 2213.

By changing the resistance value of the variable resistor 2231, the current consumption increases, and the different between the overcurrent threshold and the current consumption is reduced.

Therefore, when a short circuit occurs, the difference between the current when the FET 2213 is turned off and the current before the occurrence of a short circuit is reduced. Therefore, the voltage of the noise is reduced as illustrated on the right in FIG. 12.

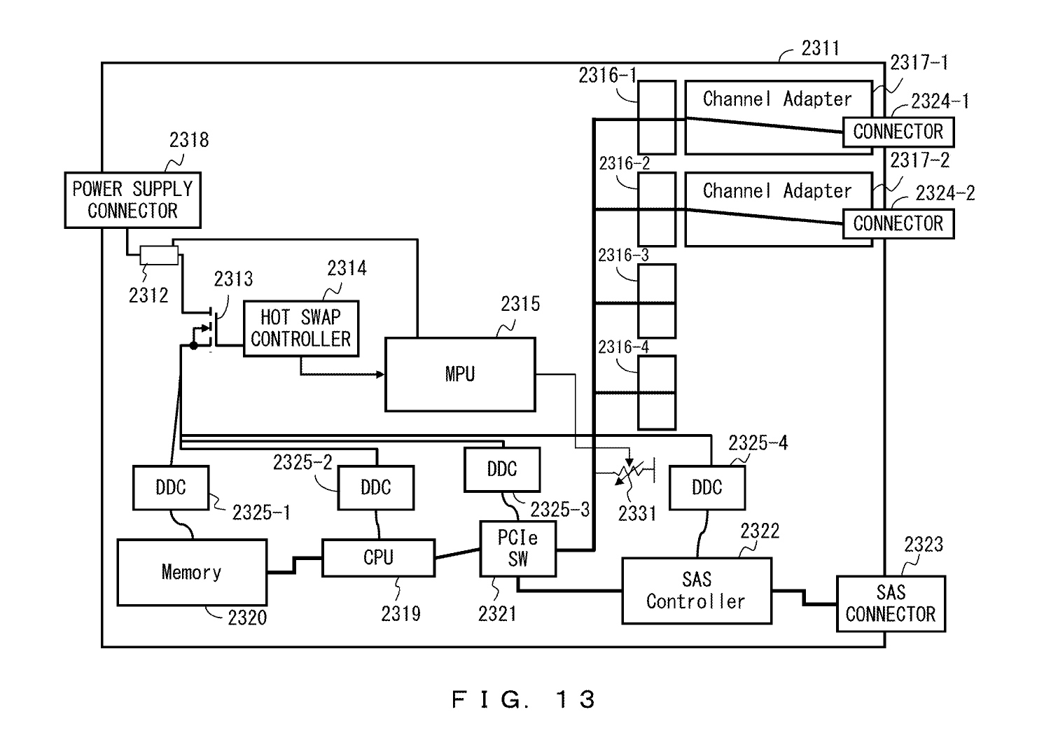

FIG. 13 is a hardware configuration of the controller module according to the second embodiment.

A controller module 2211 may be realized by, for example, a controller module 2311 as illustrated in FIG. 13.

The controller module 2311 includes a variable resistor 2312, a FET 2313, a hot swap controller 2314, an MPU 2315, a channel adaptor slot 2316-k, a channel adaptor 2317-i, a power supply connector 2318, a CPU 2319, memory 2320, a PCIe switch 2321, a serial attached SCSI (SAS) controller 2322, a SAS connector 2323, a DC-DC converter (DDC) 2325-k, and a variable resistor 2331.

The resistor 2212, the FET 2213, the hot swap controller 2214, the monitor control unit 2215, the channel adaptor slot 2216-k, the channel adaptor 2217-i, and a variable resistor 2231 in FIG. 10 respectively correspond to the variable resistor 2312, the FET 2313, the hot swap controller 2314, a MPU 2315, the channel adaptor slot 2316-k, the channel adaptor 2317-i, and a variable resistor 2331.

A power supply connector 2318, a CPU 2319, memory 2320, a PCIe switch 2321, a SAS controller 2322, a SAS connector 2323, a connector 2324, and a DDC 2325 respectively have a function similar to those of the power supply connector 1318, the CPU 1319, the memory 1320, the PCIe switch 1321, the SAS controller 1322, the SAS connector 1323, the connector 1324, and the DC-DC converter (DDC) 1325 in FIG. 9. Therefore, the descriptions are omitted below.

According to the controller module of the second embodiment, the value of the current consumption is increased by changing the resistance value of a variable resistor, and the fluctuation of the current when a short circuit occurs is reduced, thereby reducing the noise voltage. Thus, the possibility that other units which share input power supply malfunction may be reduced.

### Third Embodiment

In the second embodiment, the resistance value of the variable resistor is changed to increase the value of the current consumption, thereby wasting electric power.

In the third embodiment, the power consumption is reduced by combining the second embodiment with the first embodiment in which the overcurrent threshold is changed.

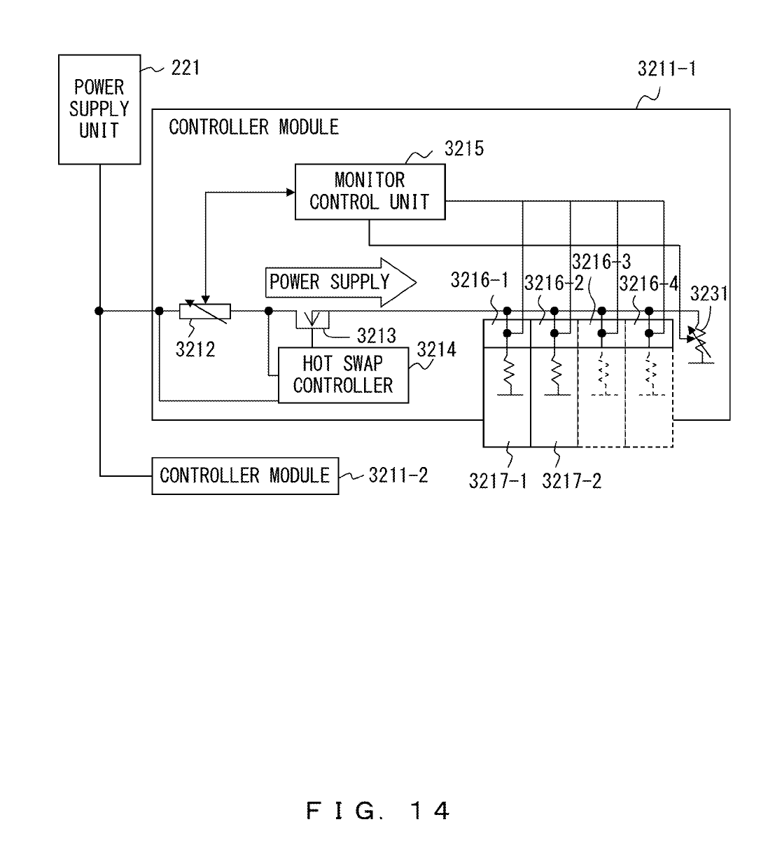

FIG. 14 is a configuration of a controller module according to the third embodiment.

The controller module 3211-i (i=1, 2) corresponds to the controller module 211-i in FIG. 3.

The controller module 3211-i is provided with power from the power supply unit 221.

The controller module 3211-2 has a configuration and a function similar to those of the controller module 3211-1. Therefore, only the controller module 3211-1 is described below.

The controller module 3211-1 includes a first variable resistor (current measurement resistance) 3212, a FET 3213, a hot swap controller 3214, a monitor control unit 3215, a channel adaptor slot 3216-k (k=1˜4), a channel adaptor 3217-i, and a second variable resistor 3231.

The variable resistor 3212 is provided between the power supply unit 221 and the FET 3213. The variable resistor 3212 is realized by, for example, a plurality of resistors connected in parallel or FET.

The drain, the gate, and the source of the FET 3213 are respectively connected to the variable resistor 3212, the hot swap controller 3214, and the channel adaptor slot 3216 and the variable resistor 3231. The FET 3213 is an example of a switch which passes or cuts off the current.

The hot swap controller 3214 controls the hot swap of the controller module 3211-1.

The hot swap controller 3214 controls the gate voltage of the FET 3213, thereby controlling the ON and OFF states of the current between the drain and the source.

The hot swap controller 3214 measures the potential difference (voltage) at both ends of the variable resistor 3212, turns of the FET 3213 when the voltage of the variable resistor 3212 is larger than the threshold (voltage threshold), thereby cutting off the current. The value obtained by dividing the voltage threshold by the resistance value of the FET 3213 is referred to as an overcurrent threshold. Since the equation “voltage=resistance×current” holds true, the hot swap controller 3214 turns off the FET 3213 and cuts off the current when the current which passes through the variable resistor 3212 is larger than the overcurrent threshold.

The monitor control unit 3215 acquires the configuration information (type and number of channel adaptors) about the channel adaptor 3217 loaded into the controller module 3211-1, and calculates the resistance value to be set in the variable resistor 3212 based on the current value table. The current value table is stored in the storage unit such as a register of the monitor control unit 3215 etc. The current value table is similar to the current value table 1221 described above with reference to the first embodiment.

The monitor control unit 3215 changes the resistance value of the variable resistor 3212 into the calculated resistance value. By changing the resistance value of the variable resistor 3212, the overcurrent threshold is also changed.

The monitor control unit 3215 acquires the value of the current of the variable resistor 3212, and calculates the resistance value set in the variable resistor 3231 based on the current of the variable resistor 3212.

The monitor control unit 3215 changes the resistance value of the variable resistor 3231 into the calculated resistance value. By changing the resistance value of the variable resistor 3231, the power consumption is also changed.

When the variable resistors 3212 and 3231 are a plurality of resistors connected in parallel, the change of the resistance value of the variable resistors 3212 and 3231 is made by switching the plurality of resistors connected in parallel. Furthermore, when the variable resistors 3212 and 3231 are FETs, the change of the resistance value is realized by controlling the gate voltage of the FET, and changing the ON resistance value.

When the configuration of the controller module 3211-1 is changed, the monitor control unit 3215 dynamically changes the resistance value of the variable resistors 3212 and 3231.

The monitor control unit 3215 is realized by, for example, a micro-processing unit (MPU) which executes firmware.

Since the channel adaptor slot 3216 and the channel adaptor 3217 have a function and a configuration similar to those of the channel adaptor slot 1216 and the channel adaptor 1217 according to the first embodiment, the descriptions are omitted below.

The variable resistor 3231 is provided parallel to the channel adaptor slot 3216. The variable resistor 3231 is realized by, for example, a plurality of resistors connected in parallel or FET.

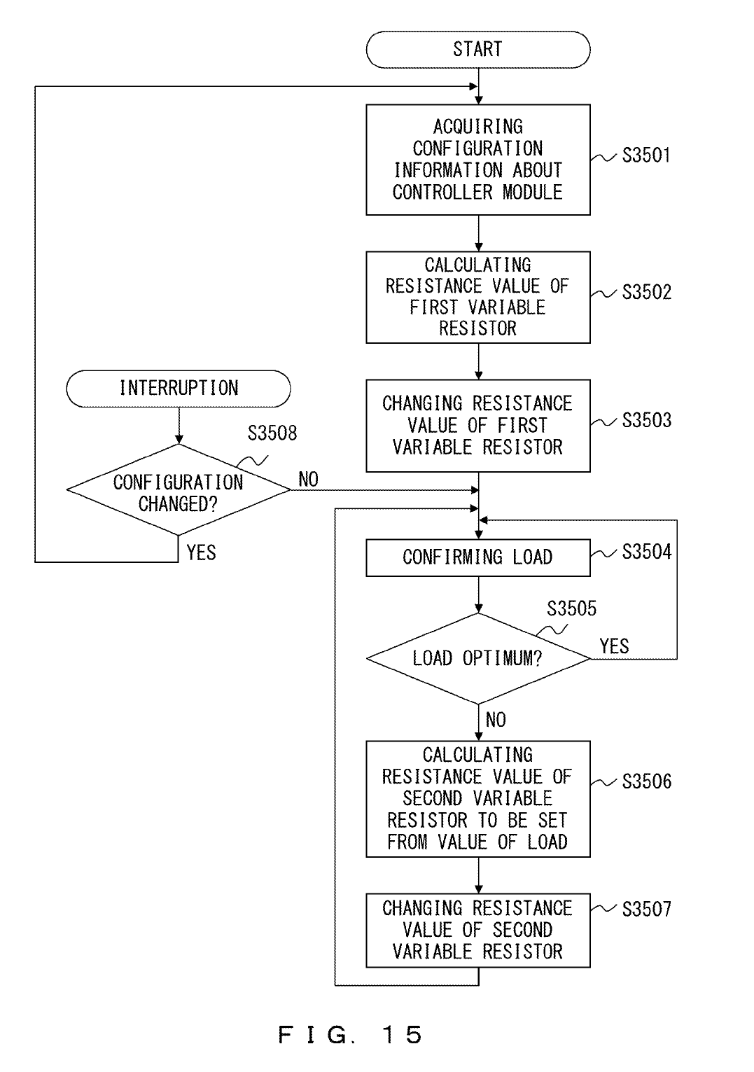

FIG. 15 is a flowchart of the variable resistance setting process according to the third embodiment.

In step S3501, the monitor control unit 3215 acquires the configuration information (type and number of channel adaptors) about the channel adaptor 3217 loaded into the controller module 3211-1. Furthermore, in the initial state, the current is prevented from passing through the variable resistor 3231. That is, the resistance value of the variable resistor 3231 is infinite.

In step S3502, the monitor control unit 3215 refers to the current value table 1221, and calculates the current consumption of the present configuration. The current consumption is calculated as a total current consumption of the channel adaptor 3217 loaded into the controller module 3211-1.

The monitor control unit 3215 calculates the resistance value of the variable resistor 3212 so that the difference between the overcurrent threshold and the current consumption may be smaller based on the voltage threshold set in the hot swap controller 3214 and the current consumption with the present configuration.

The resistance value of the variable resistor 3212 is obtained by the following equation (2).

resistance value (Ω) of variable resistor 3212=voltage threshold (V)/(coefficient (for example,1.1)*total power consumption of channel adaptor)(A) (2)

The coefficient of the equation (2) above is a real number larger than 1. However, if the coefficient is too large, the overcurrent threshold grows excessively. Therefore, the coefficient is to be an appropriate value.

In step S3503, the monitor control unit 3215 changes the resistance value of the variable resistor 3212 into the value calculated in step S3502. Thus, the value of the overcurrent threshold is also reduced.

In step S3504, the monitor control unit 3215 measures and confirms the current (current consumption) which passes through the variable resistor 3212. The current which passes through the variable resistor 3212 is also referred to as a current consumption or a load.

In step S3505, the monitor control unit 3215 judges whether or not the current consumption is appropriate. For example, when the difference between the overcurrent threshold and the current consumption is equal to or less than a specified threshold, or when the current consumption is equal to or larger than the value obtained by multiplying the overcurrent threshold by a coefficient (for example, 0.8), then it is judged that the current consumption is appropriate. That is, when the difference between the overcurrent threshold and the current consumption is small, it is judged that the current consumption is appropriate. When the current consumption is appropriate, control is returned to step S3504. When the current consumption is not appropriate, control is passed to step S3506.

In step S3506, the monitor control unit 3215 calculates the resistance value set in the variable resistor 3231 based on the present current consumption.

In detail, the monitor control unit 3215 first calculates the value of the target current consumption obtained by the equation “coefficient*threshold voltage of hot swap controller 3214/resistance value of variable resistor 3212”.

Assume that the coefficient is 0.8, the threshold voltage is 50 mv, and the resistance value of the variable resistor 3212 is 5 mΩ. Also assume that the current value in the variable resistor 3212, that is, the present current consumption is 5 A.

The coefficient is a real number larger than 0 and smaller than 1. However, when the coefficient is too small, the target current consumption is also small, and the difference between the overcurrent threshold and the target current consumption becomes larger. Therefore, the fluctuation of the current becomes large when a short circuit occurs, and the noise also becomes large. Therefore, it is assumed that the coefficient is an appropriate value which is not too small.

Therefore, the value of the target current consumption=0.8*50 mV/5 mΩ=8 A.

The insufficient current is calculated by the difference between the value of the target current consumption and the present current consumption by the equation “3 A (=8 A−5 A)”

The monitor control unit 3215 divides the voltage of the variable resistor 3231 by the insufficient current, and calculates the resistance value set in the variable resistor 3231. The voltage of the variable resistor 3231 is determined in advance, and the monitor control unit 3215 is informed of the voltage of the variable resistor 3231 in advance.

In step S3507, the monitor control unit 3215 changes the resistance value of the variable resistor 3331 into the resistance calculated in step S3506. Thus, the current (current consumption) which passes through the resistor 2212 increases.

An interruption occurs when the channel adaptor 3217 is inserted or removed, and step S3508 is executed.

In step S3508, the monitor control unit 3215 checks whether or not the configuration of the controller module 3211-1 has been changed. If the configuration of the controller module 3211-1 has been changed, control is passed to step S3501. If the configuration of the controller module 3211-1 has not been changed, control is passed to step S3504.

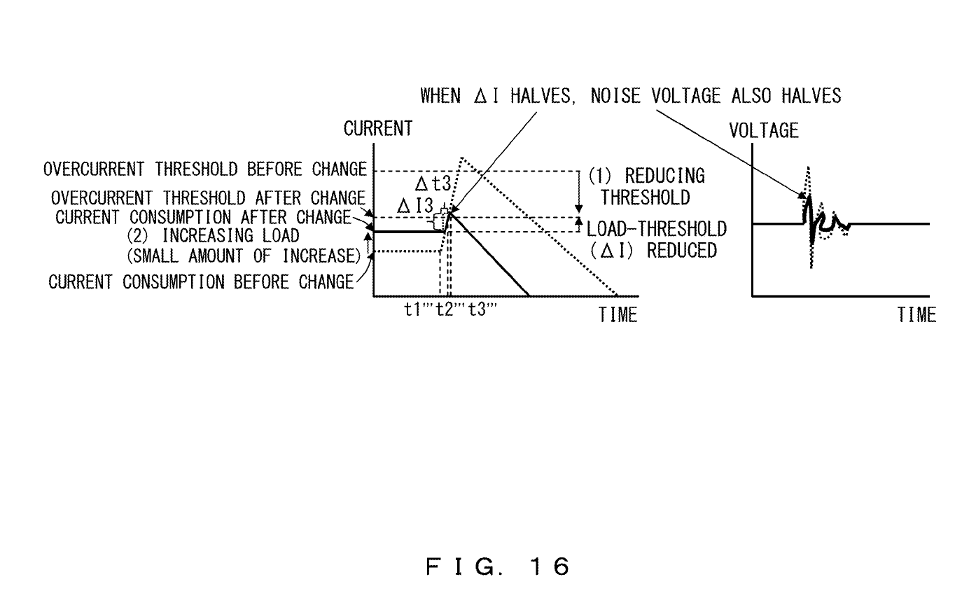

FIG. 16 is a graph of the current and the voltage when a short circuit occurs after changing the resistance value according to the third embodiment.

A graph of the current of the variable resistor 3212 is illustrated on the left in FIG. 16, and a graph of the voltage of the variable resistor 3212 is illustrated on the right in FIG. 16.

The solid line in FIG. 16 indicates current and voltage graphs after the resistance value is changed, and the dotted line indicates current and voltage graphs before the resistance value is changed (conventionally).

By executing the variable resistance setting process above, the resistance value of the variable resistor 3212 is changed, and the overcurrent threshold is lower than the resistance value of the variable resistor 3212 before the change. Furthermore, the resistance value of the variable resistor 3231 is changed, and the current consumption (load) increases as compared with the resistance value of the variable resistor 3231 before the change.

Thus, by executing the variable resistance setting process, the overcurrent threshold is reduced and the current consumption increases, thereby reducing the difference between the overcurrent threshold and the current consumption.

On the left in FIG. 16, a short circuit occurs at time t1′″, and the current increases. At time t2′″, the hot swap controller 3214 detects that the current exceeds the overcurrent threshold after the change (that is, the voltage of the variable resistor 3212 exceeds the threshold voltage). At time t3′″, the hot swap controller 3214 cuts off the current by turning off the FET 3213.

As described above, the difference between the overcurrent threshold and the current consumption is reduced by the variable resistance setting process.

Therefore, when a short circuit occurs, the difference between the current when the FET 3213 is turned off and the current before the occurrence of a short circuit is reduced. Therefore, the voltage of the noise which occurs as illustrated on the right in FIG. 16.

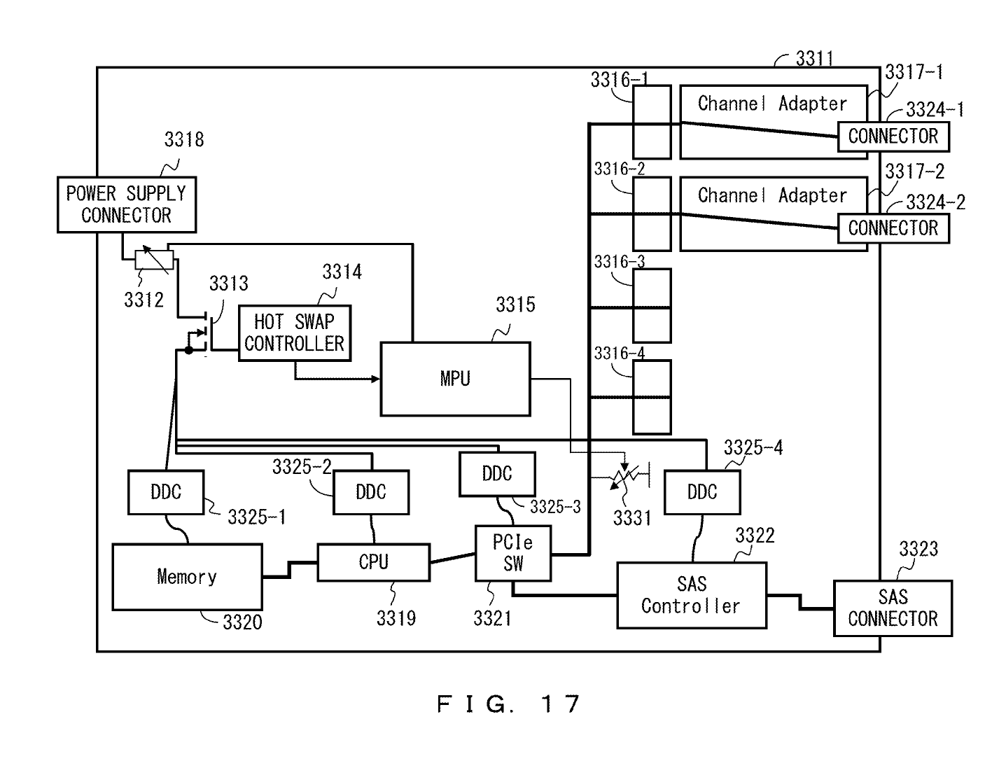

FIG. 17 is a hardware configuration of the controller module according to the third embodiment.

A controller module 3211 may be realized by, for example, a controller module 3311 as illustrated in FIG. 17.

The controller module 3311 includes a variable resistor 3312, a FET 3313, a hot swap controller 3314, an MPU 3315, a channel adaptor slot 3316-k, a channel adaptor 3317-i, a power supply connector 3318, a CPU 3319, memory 3320, a PCIe switch 3321, a serial attached SCSI (SAS) controller 3322, a SAS connector 3323, a DC-DC converter (DDC) 3325-k, and a variable resistor 3331.

The resistor 3212, the FET 3213, the hot swap controller 3214, the monitor control unit 3215, the channel adaptor slot 3216-k, the channel adaptor 3217-i, and a variable resistor 3231 in FIG. 14 respectively correspond to the variable resistor 3312, the FET 3313, the hot swap controller 3314, a MPU 3315, the channel adaptor slot 3316-k, the channel adaptor 3317-i, and a variable resistor 3331.

A power supply connector 3318, a CPU 3319, memory 3320, a PCIe switch 3321, a SAS controller 3322, a SAS connector 3323, a connector 3324, and a DDC 3325 respectively have a function similar to those of the power supply connector 1318, the CPU 1319, the memory 1320, the PCIe switch 1321, the SAS controller 1322, the SAS connector 1323, the connector 1324, and the DC-DC converter (DDC) 1325 in FIG. 9. Therefore, the descriptions are omitted below.

According to the controller module of the third embodiment, the overcurrent threshold is reduced by changing the resistance value of the first variable resistor, and the fluctuation of the current when a short circuit occurs is reduced, thereby reducing the noise voltage.

According to the controller module of the third embodiment, the value of the current consumption is increased by changing the resistance value of the second variable resistor, and the fluctuation of the current when a short circuit occurs is reduced, thereby reducing the noise voltage. Thus, the possibility that other units which share input power supply malfunction may be reduced.

All examples and conditional language provided herein are intended for pedagogical purposes of aiding the reader in understanding the invention and the concepts contributed by the inventor to further the art, and are to be construed as being limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A processing device, comprising:
a channel adaptor connected to an external device;
a first resistor provided parallel to the channel adaptor, and has a variable resistance value;
a processor to control the resistance value of the first resistor;
a power supply device to provide power for the channel adaptor and the first resistor;
a second resistor provided between the power supply device and the channel adaptor;
a switch to control continuity of a current from the power supply device to the channel adaptor and the first resistor; and
a controller to monitor a voltage of the second resistor, and turn off the switch when the voltage is larger than a threshold, wherein
the processor
calculates a resistance value to be set in the first resistor based on a current of the second resistor, the threshold, and a resistance value of the second resistor; and
sets the calculated resistance value as the resistance value of the first resistor.

2. The processing device according to claim 1, wherein
the processor
calculates a target current consumption by multiplying a coefficient by the threshold and dividing a value obtained from the multiplying by the resistance value of the second resistor,
calculates an insufficient current consumption from a difference between the target current consumption and the current of the second resistor; and
calculates the resistance value to be set in the first resistor by dividing a voltage of the first resistor by the insufficient current consumption.

3. The processing device according to claim 1, wherein:
the second resistor has a variable resistance value;
the processor
calculates a resistance value to be set in the second resistor based on the threshold and a current consumption of the channel adaptor; and
sets the calculated resistance value as the resistance value of the second resistor.

4. The processing device according to claim 3, wherein
the processor calculates the resistance value to be set in the second resistor by dividing the threshold by a value obtained from multiplying the current consumption of the channel adaptor by a coefficient which is larger than 1.

5. A method for reducing noise using a processing device including a channel adaptor connected to an external device, a first resistor provided parallel to the channel adaptor and has a variable resistance value, a processor to control the resistance value of the first resistor, a power supply device to provide power for the channel adaptor and the first resistor, a second resistor provided between the power supply device and the channel adaptor, a switch to control continuity of a current from the power supply device to the channel adaptor and the first resistor, and a controller to monitor a voltage of the second resistor and turn off the switch when the voltage is larger than a threshold, the method comprising:
confirming a current of the second resistor;
calculating a resistance value to be set in the first resistor based on the current of the second resistor, the threshold, and a resistance value of the second resistor; and
setting the calculated resistance value as the resistance value of the first resistor.

6. The method according to claim 5, wherein
the calculating the resistance value to be set in the first resistor calculates a target current consumption by multiplying a coefficient by the threshold and dividing a value obtained from the multiplying by the resistance value of the second resistor, calculates an insufficient current consumption from a difference between the target current consumption and the current of the second resistor, and calculates the resistance value to be set in the first resistor by dividing a voltage of the first resistor by the insufficient current consumption.

7. The method according to claim 6, wherein:
the second resistor has a variable resistance value; and
the method further comprises:
calculating a resistance value to be set in the second resistor based on the threshold and a current consumption of the channel adaptor; and
setting the calculated resistance value as the resistance value of the second resistor.

8. The method according to claim 7, wherein
the calculating the resistance value of the second resistor calculates the resistance value to be set in the second resistor by dividing the threshold by a value obtained from multiplying the current consumption of the channel adaptor by a coefficient which is larger than 1.
